(19) United States
(12) Patent Application Publication
(10) Pub. No.: US 2008/0193652 A1
(43) Pub. Date: Aug. 14, 2008

(54) METHOD OF COATING A COMPONENT

(75) Inventors: Dominique De Figueiredo Gomes, Apensen (DE); Volker Abetz, Aumuhle (DE); Bobby Kannan Mathan, Coimbatore (IN); Wolfgang Dietzel, Geesthacht (DE)

Correspondence Address: MICHAUD-DUFFY GROUP LLP, 306 INDUSTRIAL PARK ROAD, SUITE 206, MIDDLETOWN, CT, 06457, US

(73) Assignee: GKSS-FORSCHUNGSZENTRUM GEESTHACHT GMBH, Geesthacht (DE)

(21) Appl. No.: 12/030,240

(22) Filed: Feb. 13, 2008

(30) Foreign Application Priority Data
Feb. 14, 2007 (DE) 10 2007 007 879.1

(51) Int. Cl. B05D 3/00

(52) U.S. Cl. 427/327; 427/384; 427/386; 427/383.1; 427/299

(57) ABSTRACT

A method of coating a component on a surface thereof includes applying an organic polyoxazole-containing polymer solution to the surface and, in a further step, drying the applied polymer solution to form a coating on the surface. A coating on a component, more particularly a corrosion-resistant coating, comprises a solution of an organic polyoxazole-containing polymer. The solution is applied to a surface of the component in order to coat the surface. The surface being coated may be metal.

### CROSS REFERENCE TO RELATED APPLICATION

This application claims priority to German Patent Application No. 10 2007 007 879.1 filed Feb. 14, 2007, the entire disclosure of which is herein incorporated by reference in its entirety.

### TECHNICAL FIELD

The present invention relates to a method of coating a component on a surface thereof. The present invention also relates to a coating that can be applied to a component and, more particularly, to a corrosion-resistant coating where a solution is applied to a preferably metallic surface of the component in order to coat the surface. The invention further relates to a use with a coating solution.

### BACKGROUND

Magnesium and its alloys are lightweight and base-metallic materials of construction. Magnesium and the alloys formed from it therefore have a very strong tendency towards corrosion.

The corrosion behavior of magnesium and magnesium surfaces can be modified by conversion coats or reaction layers and by organic or inorganic coatings. For example, in processes where an anodic oxidation or substrate surface takes place in an electrolyte plasma, solid and dense layers of magnesium oxides and/or magnesium phosphates are produced, which thereby provide an electrical insulation effect and good wear resistance. These coats and layers, however, normally also require sealing by an organic coating (top coat) in order to ensure long-term corrosion protection. Moreover, these processes are comparatively costly.

Magnesium, despite possessing good corrosion resistance in air, is nevertheless unstable in solutions containing chloride, sulfate, carbonate, and nitrate. Magnesium alloys form stable surface films at pH levels above 11; however, for the pH range between 4.5 and 8.5 (which is, for example, the range in which aluminum develops stable surface films), there are no effective protective layers which self-heal in the event of damage.

Magnesium, moreover, is the basest material of construction, meaning that, on the one hand, it tends towards severe breakdown following microgalvanic corrosion induced more particularly by impurities containing Fe, Ni, and Co, and, on the other hand, in the case of magnesium alloys, there is internal galvanic corrosion owing to a second, more noble phase or to the presence of inclusions. Since magnesium is frequently employed in conjunction with more noble materials, components are typically coated for the purpose of avoiding contact corrosion in the case of applications in aggressive media and/or in the presence of water.

Depending on use and deployment, the corrosion behavior and wear behavior of magnesium surfaces can be modified by conversion coats or reaction layers or by organic or inorganic coatings.

For example, US 2006/0063872 A1, EP 0 949 353 B1, US 2005/0067057 A1, U.S. Pat. No. 4,973,393, U.S. Pat. No. 5,993,567, WO 99/02759 A1 and DE 199 13 242 C2 describe methods or measures for the corrosion protection of magnesium and its alloys.

On the basis of the foregoing, one object of the present invention is to provide a favorable and simple corrosion-resistant and also chromium-free coating for components, more particularly for magnesium materials or components made of magnesium or magnesium alloys, or for components with magnesium-containing surfaces, the intention being that the coating should be resistant even at relatively high temperatures.

### SUMMARY OF THE PRESENT INVENTION

In one aspect, the present invention resides in a method of coating a component. This coating is typically applied to a surface of the component. In doing so, an organic polyoxazole-containing polymer solution is applied to the surface and dried to form the desired coating. The surface to which the coating is applied may be a metallic surface.

In another aspect, the present invention resides in a corrosion-resistant coating for a component. This coating comprises a solution of an organic polyoxazole-containing polymer that is applied to a surface of the component, thereby coating the surface. The surface to which the solution is applied may be a metallic surface.

### BRIEF DESCRIPTION OF THE DRAWINGS

FIG. 1 shows an electrochemical impedance spectrum of an uncoated magnesium alloy;

FIG. 2 shows an electrochemical impedance spectrum of a coated magnesium alloy; and

FIG. 3 shows polarization curves for coated and uncoated magnesium alloys.

### DETAILED DESCRIPTION OF THE PREFERRED EMBODIMENTS

In a method of coating a surface of a component, an organic polyoxazole-containing polymer solution is applied in the form of a solution to the surface and dried to form a coating. The surface being coated may be metallic.

By means of a polyoxazole-based organic coating for components, a corrosion-resistant coating or corrosion coating is provided. The proposed coating method is of low complexity and is inexpensive. The components are preferably produced from a magnesium material so that the coating produced or applied provides a polymer-based, chromium-free corrosion protection for the components or for magnesium or its alloys. Additionally, the coating solution or polymer solution can comprise fluorine-containing polyoxazoles which are soluble in aprotic organic solutions.

In accordance with the present invention, therefore, a corrosion coating is provided on a metallic component, preferably on a magnesium surface of a component, an aprotic organic polyoxazole solution being applied to the surface and, in a further step, the applied polymer solution being dried so that a coating (or one or more layers of coating) is formed on the surface.

For this purpose it is provided that before the organic polyoxazole-containing polymer solution is applied to the surface, polyoxazole polymers and/or polyoxazole copolymers are dissolved in an organic, preferably aprotic, solution to give a polymer solution. The solvent in the polymer solution inhibits corrosion on the metallic surface, more particularly corrosion of magnesium or magnesium-alloy surfaces of the component. Moreover, the aprotic solvent is immiscible in acid and protic solvents.

If, moreover, polyoxadiazole is used in the polymer solution, the water permeability of the coating produced on the surface of the component or magnesium material is low. The proposed polymer coating of the invention has the added advantage that a chromium-free coating composition or coating is proposed for metallic surfaces, more particularly for magnesium and its alloys.

The chromium-free, corrosion-resistant coating solution with polyoxazole polymers or copolymers enhances the resistance of the coated surface to solvents, water, moisture, scratching (e.g., mechanical damage), and corrosion of metallic surfaces and their alloys.

Also, conductive or nonconductive fillers or filling materials can be dissolved and/or generated, preferably in situ, and/or suspended in the polymer solution. This step of the method is performed more particularly when the polymers or copolymers with polyoxazole are in solution in the organic solvent.

In order to promote durable corrosion protection, one embodiment proposes that the surface of the component, before the polymer solution is applied, is or has been treated. Treatment of the surface may be effected by a cleaning process.

Moreover, the method further includes a step whereby the coating or polymer solution applied to the surface of the component is dried at a temperature of below 100° C., preferably below 80° C. As a result of this drying, the cast polymer solution or suspension (with fillers) applied to the surface of the component or the magnesium material is developed into a coating film on the surface.

Furthermore, it is advantageous if the polyoxazole-containing polymer solution contains polyoxadiazoles and/or polytriazoles and/or poly(oxadiazole-co-triazoles) and/or poly(hydrazide-co-oxadiazoles) and/or poly(hydrazide-co-oxadiazole-co-triazoles) and/or poly(ether sulfone-co-oxadiazoles) and/or poly(ether ketone-co-oxadiazoles) and/or poly(ether amide-co-oxadiazoles) and/or poly(hydrazide-co-triazoles) and/or poly(ether sulfone-co-triazoles) and/or poly(ether ketone-co-triazoles) and/or poly(ether amide-co-triazoles).

More particularly the polymer has the following structure:

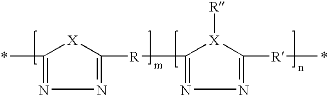

where X is O or N, R″ can be H, a halogen atom, or an organic group, and R and R′ are organic groups. More particularly it is preferred if the organic groups for R, R′, and/or R″ are polyoxazoles containing fluorine atoms in order to lower the water absorption.

The polyoxazole in the polymer solution more particularly contains at least one conjugated 5-membered heterocyclic ring having two or more nitrogen atoms. In one embodiment, the nitrogen atoms in the conjugated ring are joined alongside one another or separated by other atoms.

Preferably the polymer has the following structure:

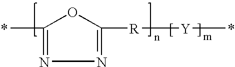

where R is a group having 1 up to 40 carbon atoms which preferably contains fluorine atoms,
Y is at least one or more groups of the following formulae:

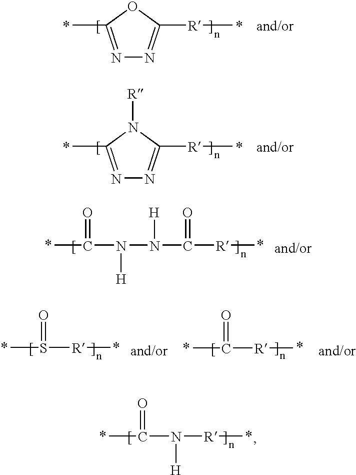

where R′ is a group having 1 up to 40 carbon atoms, and where R″ is a hydrogen atom or a group having between 1 and 40 carbon atoms.

The polyoxazoles can occur in the form of block copolymers (diblock or triblock), in the form of random copolymers, periodic copolymers, and/or alternating copolymers, where n and m are natural numbers.

In some embodiments, the polymer solution or the polymers may contain at least one polyoxazole functionalized with at least one acid group.

According to a further embodiment the polymer solution of the invention contains oligomers or polymers which are from the group of polyanilines, polypyrroles, polythiophenes, polyacrylics, polyethers, epoxy, polyesters, polyethylenes, polyamides, polyimides, polypropylenes, polyurethanes, polyolefins, polydienes, hydroxy polymers, polyanhydrides, polysiloxanes, polyhydrazides, polysulfones, polyvinyls, and mixtures of these stated substances and/or of copolymers derived therefrom. More particularly, according to one development, the oligomers or polymers have been or are functionalized by one functional or two or more functional acid groups. Moreover, it is of advantage if the filler or filling material is silicon dioxide, a product from a sol-gel process, aluminum, titanium, montmorillonite, silicate, or a combination of one or more of the foregoing materials. Any of the foregoing fillers or filling materials may be functionalized.

In order to lower the water permeability, fillers or filling materials (more particularly nonconducting fillers or filling materials) are incorporated into the polymer solution. Generally speaking, the permeability will decrease when the volume fraction of the fillers or filling materials in the polymer solution increases. At the same time this improves the thermal and/or mechanical properties of the coating.

The filler can be a functionalized carbon nanotube, molecular sieve carbon, graphite, pyrolyzed polyoxazole particles, or a combination of any of the foregoing materials. This further enhances the corrosion resistance of the coating on the surface.

It is further of advantage, additionally, if the fraction of the filler is greater than 0.5% by weight, preferably greater than 5% by weight, more preferably greater than 20% by weight, in the polymer solution. For this purpose it is preferred for the particles of the fillers to be well dispersed in the polymer layer or polymer solution, so that a uniform coating on the surface is achieved. In order to increase the adhesion of the coating solution or coating to the metallic surface of the component, it is preferred for the thickness of the coating or of the applied coating film or coating layer to be at least greater than 1 μm, preferably greater than 10 μm, more preferably greater than 50 μm.

The object may be further achieved by a coating on a component, preferably a corrosion-resistant chromium-free coating, a coating solution having been or being applied to a preferably metallic surface of the component in order to coat the surface, as a coating layer or film, the coating being developed in that the coating solution is an organic polyoxazole-containing polymer solution.

More particularly the organic polyoxazole-containing polymer solution can be dried to form a coating on the surface of the component or magnesium material. Advantageously, in the polymer solution, polyoxazole polymers and/or polyoxazole copolymers can be dissolved in an organic, preferably aprotic, solution to give or obtain a polymer solution. For this purpose it is further favorable if, in the polymer solution, conductive or nonconductive fillers are dissolved, generated, and/or suspended. When such fillers are generated, they may be generated in situ.

For this purpose provision is additionally made for the surface of the component before the polymer solution is applied to be treated, preferably cleaned. After the coating has been poured on or applied to the surface, the polymer solution or coating applied to the surface of the component is or has been dried at a temperature of below 100° C., preferably below 80° C.

The object may be further achieved through the use of a coating solution to coat a component, the coating on the component having the composition or taking the form as described above.

The method of the invention and the coating of the invention achieve efficient corrosion protection for components and structural parts made from magnesium materials, the coating method being simple and cost-effective. Furthermore, the applied coating on a component has the advantage that the coating or the coating layers or corrosion coating films are resistant even at relatively high temperatures, thereby allowing a coating to be produced prior to a forming operation, on metal sheets, for example, with the corrosion protection continuing before and during the forming operation.

Moreover, through the incorporation of appropriate reagents and/or compounds, it becomes possible to promote healing of the coating in the event of mechanical damage. More particularly, use is made of a fluorine-containing polymer or a fluorine-containing polymer solution (coating solution) which results in a low level of water absorption.

The invention is described exemplarily below, without restriction of the general concept of the invention, using working examples, which do not restrict the scope or possible application of the invention.

### EXAMPLES

### Example 1

### Polymer Synthesis

Poly(2,2-bis(4-phenyl)hexafluoropropane-1,3,4-oxadiazole) was synthesized. In this case an optimized polyoxadiazole synthesis was performed. Following the reaction of 4,4′-dicarboxyphenylhexafluoropropane (99%, Aldrich) and hydrazine sulfate (>99%, Aldrich) at 160° C. for 3 hours, the reaction medium was poured into water containing 5% sodium hydroxide (99%, Vetec) to deposit the polymer. The pH of this polymer suspension was monitored.

The chemical structure of the polymer is shown below:

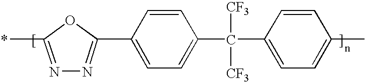

C₁₇H₈N₂O₁D₆ (370); calculated (%) C 55.1, H 2.2, N 7.6. found C 55.3, H 3.2, N 6.6.

This gave polyoxadiazole with a yield of 89%, which is soluble in the solvents NMP, DMSO, CF₃COOH, CHCl₃, and THF, with an average molecular mass weight corresponding to 200,000 g/mol as determined by SEC (size exclusion chromatography).

This size exclusion chromatography was performed using a size exclusion chromatograph (from Viscotek which was equipped with Eurogel columns SEC 10 000 and PSS Gram 100, 1000, with the serial numbers HC286 and 1515161, and sizes of 8×300 mm.) The SEC instrument from Viscotek was used in order to determine the average molecular weight of the polymers. A calibration was carried out using polystyrene standards (Merck) having average molecular weights between 309 to 944,000 g/mol. A solution with 0.05 M lithium bromide in DMAc was used as a carrier.

### Example 2

### Coatings on Magnesium

Homogeneous coatings were prepared by pouring the polymer solution, with a concentration of 4% by weight in NMP, after filtering, on a surface of an AM50 magnesium alloy and carrying out drying at 60° C. for a period of 24 hours. Before the polymer solution and the coating were applied, the samples of the magnesium alloys were polished with silicon carbide having a grade of up to 2500, washed in distilled water, and cleaned in acetone with ultrasound. To remove the remaining solvent, the coated magnesium was placed in a vacuum oven at 80° C. for a period of 24 hours. The final thickness of the polymer coating was approximately 10 μm.

### Example 3

### Preparation of the Film

Homogeneous films of the polymer solutions, with a concentration of 4% by weight in NMP, and having been filtered beforehand, were cast on a polytetrafluoroethylene-coated surface at 60° C. The films were dried for 24 hours and then easily removed from the plate. The films were subsequently dried in a vacuum oven at 80° C. for 24 hours in order to remove residues of the solvent. The final thickness of the films was approximately 10 μm.

Water Absorption Measurements

The films were dried at 80° C. overnight before the measurements were carried out. After the weights of the dry films had been measured, the samples were immersed in a 0.1 M NaCl solution at room temperature (21° C.) for 66 hours. Before the weights of the hydrated films were measured, the water was removed from the film surface by dabbing with a paper towel. The water absorption was calculated in accordance with the following equation:

$$Water absorption ( \% ) = \frac{( {weight}_{liquid} - {weight}_{dry} )}{{weight}_{dry}} \times 100$$

In this equation, weight_{dry} and weight_{wet} are the weights of the dried and wet samples, respectively.

In the case of the POD6F films, no water absorption was observed after 66 hours. In this case the chemical bond between the carbon atoms and the fluorine atoms is very strong. When fluorine is part of a molecule, it repels other molecules such as water, for example, even when the other molecules contain fluorine atoms.

### Example 4

### Impedance Spectroscopy

Investigations with electrochemical impedance spectroscopy (EIS) were carried out following exposure of the samples in a 0.1 M NaCl solution for a period of 2 hours, 36 hours, and 72 hours. The EIS experiments were carried out in a frequency range between 0.001 Hz and 30 kHz, a frequency analyzer having been used (manufactured by Gill AC, ACM Instruments, Great Britain).

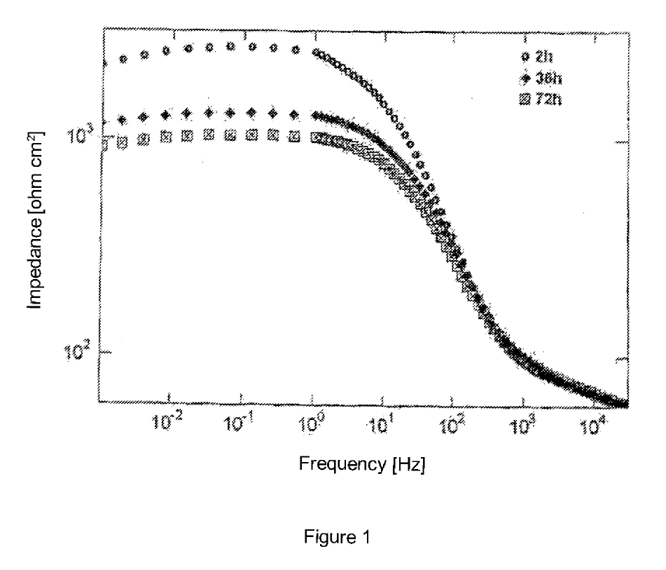

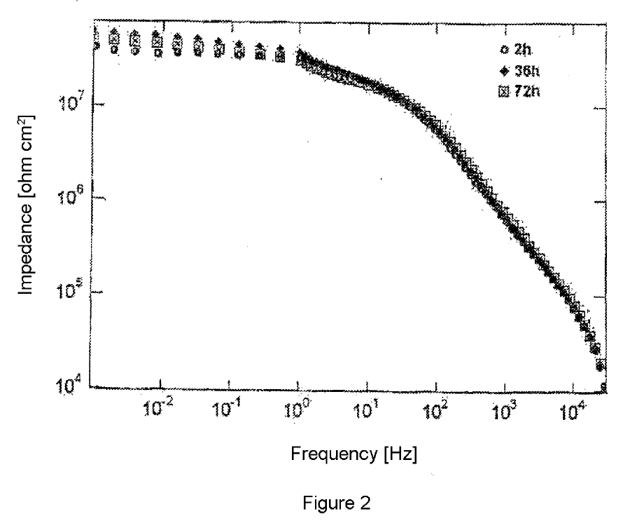

FIGS. 1 and 2 show the plots for the impedance spectroscopy for uncoated metal surfaces and samples (FIG. 1) and for coated samples (FIG. 2).

The samples coated with polyoxadiazole (FIG. 2) show a distinct improvement in corrosion resistance over the untreated samples (FIG. 1). The corrosion resistance of polyoxadiazole-coated samples is approximately 5 orders of magnitude higher than that of bare metal surfaces. For uncoated alloys the corrosion resistance decreases over time. After bath immersion for 36 hours, the polarization resistance in the case of the uncoated sample was 1.31 10³ Ωcm², while for the coated magnesium alloy sample with polyoxadiazole the coating resistance after 36 hours was held constant at a figure of 8.0 10⁷ Ωcm² (FIG. 2).

### Example 5

### Electrochemical Polarization

The electrochemical polarization studies were performed using a computer-controlled potentiostat/galvanostat and with an electrochemical corrosion cell with samples as the working electrode, platinum gauze as the counter electrode, and an Ag/AgCl electrode as the reference electrode. The experiments were carried out in a 0.1 M NaCl solution with a scan rate of 1 mV/s.

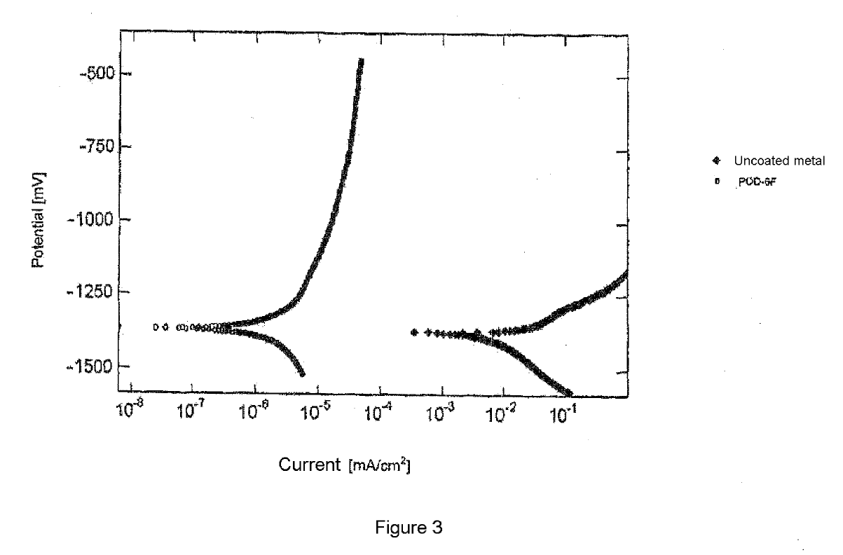

The polarization plots of the bare, i.e., uncoated, metal and of the coated samples (POD6F films) in 0.1 M NaCl are shown in FIG. 3. The polyoxadiazole-coated samples show a significant improvement in corrosion resistance over the uncoated metal. The corrosion current density of polyoxazole-coated samples has decreased from 5.6×10⁻³ mA/cm² to 1.4×10⁻⁶ mA/cm².

Furthermore, the samples coated with polyoxazole exhibit no collapse of the potential, even at up to 1000 mV above the corrosion potential. This demonstrates the greater stability of the coating on samples in a corrosive environment.

The corrosion resistance of the polymer layers on a surface was carried out by means of electrochemical impedance spectroscopy measurements (EIS) and polarization studies in a 0.1 M NaCl solution. The polarization studies are shown as records of potentiostatic/galvanostatic voltage/current density plots. Not only the results of the EIS studies, which have been plotted in what are called Bode diagrams as the logarithm of the impedance |Z| over the logarithm of the frequency (cf. FIGS. 1 and 2), but also the voltage/current density plots recorded (FIG. 3) show a significant improvement in the corrosion resistance of the inventively coated magnesium substrates.

What is claimed is:

1. A method of coating a component on a surface thereof, said method comprising the steps of:
applying an organic polyoxazole-containing polymer solution to the surface; and
drying the applied polymer solution to form a coating on the surface.

2. The method of claim 1, wherein the surface is a metallic surface.

3. The method according to claim 1, further comprising the step of dissolving at least one of a polyoxazole polymer and a polyoxazole copolymer in an organic solvent to give the polymer solution,
wherein the step of dissolving is carried out before the organic polyoxazole-containing polymer solution is applied to the surface.

4. The method according to claim 3, wherein the organic solvent is an aprotic solvent.

5. The method according to claim 3, further comprising the step of at least one of dissolving, generating, and suspending a filler in the polymer solution.

6. The method according to claim 5, wherein the fillers are generated in situ in the polymer solution.

7. The method according to claim 1, further comprising the step of treating the surface of the component before the polymer solution is applied.

8. The method according to claim 7, wherein the step of treating the surface comprises cleaning the surface.

9. The method according to claim 1, wherein the step of drying the polymer solution applied to the surface of the component comprises drying at a temperature of below 100° C.

10. The method according to claim 1, wherein the step of drying the polymer solution applied to the surface of the component comprises drying at a temperature of below 80° C.

11. The method according to claim 1, wherein the polyoxazole in the polymer solution comprises at least one conjugated 5-membered heterocyclic ring having two or more nitrogen atoms.

12. The method according to claim 1, wherein the polymer has the following structure: 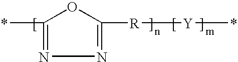
where R is a group having 1 up to 40 carbon atoms,
Y is at least one or more groups of the following formulae: 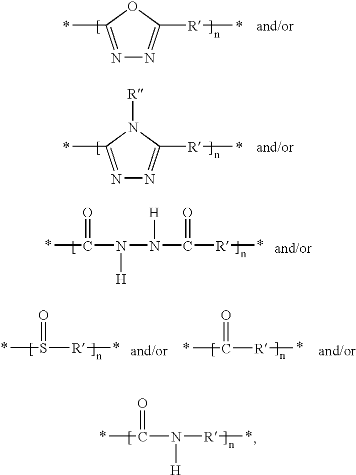
where R′ is a group having 1 up to 40 carbon atoms, and
where R″ is selected from the group consisting of a hydrogen atom and a group having 1 up to 40 carbon atoms.

13. The method according to claim 12, wherein R is a group having 1 up to 40 carbon atoms which contains fluorine atoms.

14. The method according to claim 1, wherein the polyoxazole-containing polymer solution contains a material selected from the group consisting of polyoxadiazoles, polytriazoles, poly(oxadiazole-co-triazoles), poly(hydrazide-co-oxadiazoles), poly(hydrazide-co-oxadiazole-co-triazoles), poly(ether sulfone-co-oxadiazoles), poly(ether ketone-co-oxadiazoles), poly(ether amide-co-oxadiazoles), poly(hydrazide-co-triazoles), poly(ether sulfone-co-triazoles), poly(ether ketone-co-triazoles), poly(ether amide-co-triazoles), and combinations of the foregoing materials.

15. The method according to claim 1, wherein at least one of the polymer solution and the polymers contain at least one polyoxazole functionalized with at least one acid group.

16. The method according to claim 1, wherein the polymer solution contains at least one of oligomers and polymers selected from the group consisting of polyanilines, polypyrroles, polythiophenes, polyacrylics, polyethers, epoxy, polyesters, polyethylenes, polyamides, polyimides, polypropylenes, polyurethanes, polyolefins, polydienes, hydroxy polymers, polyanhydrides, polysiloxanes, polyhydrazides, polysulfones, polyvinyls, copolymers derived from of any of the foregoing, and mixtures of any of the foregoing.

17. The method according to claim 16, wherein the at least one of the oligomers and polymers are functionalized by one functional group.

18. The method according to claim 16, wherein the at least one of the oligomers and polymers are functionalized by two or more acid groups.

19. The method according to claim 5, wherein the filler is selected from the group consisting of silicon dioxide, a product from a sol-gel process, aluminum, titanium, montmorillonite, -silicate, and combinations of the foregoing.

20. The method according to claim 19, wherein the filler is functionalized.

21. The method according to claim 5, wherein the filler is selected from the group consisting of carbon nanotubes, molecular sieve carbon, graphite, pyrolyzed polyoxazole particles, and combinations of the foregoing.

22. The method according to claim 21, wherein the carbon nanotubes are functionalized.

23. The method according to claim 5, wherein a fraction of the filler is more than 0.5% by weight in the polymer solution.

24. The method according to claim 5, wherein a fraction of the filler is more than 5% by weight in the polymer solution.

25. The method according to claim 5, wherein a fraction of the filler is more than 20% by weight in the polymer solution.

26. The method according to claim 1, wherein a thickness of the coating is at least greater than 1 μm.

27. The method according to claim 1, wherein a thickness of the coating is at least greater than 10 μm.

28. The method according to claim 1, wherein a thickness of the coating is at least greater than 50 μm.

29. A corrosion-resistant coating on a component, comprising:
a solution comprising an organic polyoxazole-containing polymer;
wherein the solution is applied to a surface of the component in order to coat the surface.

30. The coating according to claim 29, wherein the solution is applied to a metallic surface of the component.

31. A coating according to claim 29, wherein the organic polyoxazole-containing polymer solution is dried to form the coating on the surface.

32. The coating according to claim 29, wherein at least one of polyoxazole polymers and polyoxazole copolymers are dissolved in an organic solvent to form the polymer solution.

33. The coating according to claim 32, wherein the solvent is an aprotic solvent.

34. The coating according to claim 29, wherein a filler is included in the polymer solution by being at least one of dissolved, generated, and suspended in the polymer solution.

35. The coating according to claim 34, wherein the fillers are generated in situ in the polymer solution.

36. The coating according to claim 29, wherein the surface of the component is treated before the polymer solution is applied.

37. The coating according to claim 36, wherein the surface of the component has been cleaned.

38. The coating according to claim 29, wherein the polymer solution applied to the surface of the component is dried at a temperature of below 100° C.

39. The coating according to claim 29, wherein the polymer solution applied to the surface of the component is dried at a temperature of below 80° C.

40. The coating according to claim 29, wherein the polyoxazole-containing polymer solution contains a material selected from the group consisting of polyoxadiazoles, polytriazoles, poly(oxadiazole-co-triazoles), poly(hydrazide-co-oxadiazoles), poly(hydrazide-co-oxadiazole-co-triazoles), poly(ether sulfone-co-oxadiazoles), poly(ether ketone-co-oxadiazoles), poly(ether amide-co-oxadiazoles), poly(hydrazide-co-triazoles), poly(ether sulfone-co-triazoles), poly(ether ketone-co-triazoles), poly(ether amide-co-triazoles), and combinations of the foregoing material.

41. A coating according to claim 29, wherein at least one of the polymer solution and the polymers contain at least one polyoxazole functionalized with at least one acid group.

42. A coating according to claim 29, wherein the polymer solution contains at least one of oligomers and polymers selected from the group consisting of polyanilines, polypyrroles, polythiophenes, polyacrylics, polyethers, epoxy, polyesters, polyethylenes, polyamides, polyimides, polypropylenes, polyurethanes, polyolefins, polydienes, hydroxy polymers, polyanhydrides, polysiloxanes, polyhydrazides, polysulfones, polyvinyls, copolymers derived from of any of the foregoing, and mixtures of any of the foregoing.

43. A coating according to claim 42, wherein the at least one of the oligomers and polymers are functionalized by one functional group.

44. The coating according to claim 42, wherein the at least one of the oligomers and polymers are functionalized by two or more acid groups.

45. The coating according to claim 34, wherein the filler is selected from the group consisting of silicon dioxide, a product from a sol-gel process, aluminum, titanium, montmorillonite, -silicate, and combinations of the foregoing.

46. The coating according to claim 45, wherein the filler is functionalized.

47. The coating according to claim 34, wherein the filler is selected from the group consisting of carbon nanotubes, molecular sieve carbon, graphite, pyrolyzed polyoxazole particles, and combinations of the foregoing.

48. The coating according to claim 34, wherein the carbon nanotubes are functionalized.

49. The coating according to claim 34, wherein a fraction of the filler is more than 0.5% by weight in the polymer solution.

50. The coating according to claim 34, wherein a fraction of the filler is more than 5% by weight in the polymer solution.

51. The coating according to claim 34, wherein a fraction of the filler is more than 20% by weight in the polymer solution.

52. The coating according to claim 29, wherein a thickness of the coating is at least greater than 1 μm.

53. The coating according to claim 29, wherein a thickness of the coating is at least greater than 10 μm.

54. The coating according to claim 29, wherein a thickness of the coating is at least greater than 50 μm.
